(19) United States
(12) Patent Application Publication
(10) Pub. No.: US 2017/0280224 A1
(43) Pub. Date: Sep. 28, 2017

(54) ACCESSORY FOR PORTABLE TERMINAL

(71) Applicant: CRESYN CO., LTD., Seoul (KR)

(72) Inventors: Jong Bae LEE, Seoul (KR); Koo Tack PARK, Seoul (KR); Tae Young KIM, Seoul (KR)

(73) Assignee: CRESYN CO., LTD., Seoul (KR)

(21) Appl. No.: 15/503,952

(22) PCT Filed: Oct. 1, 2014
(86) PCT No.: PCT/KR2014/009245

§ 371 Date: Feb. 14, 2017

(30) Foreign Application Priority Data
Sep. 23, 2014 (KR) 10-2014-0126546

(51) Int. Cl. H04R 1/10; H01R 24/58

(52) U.S. Cl. CPC H04R 1/1041; H01R 24/58; H04R 2420/05; H04R 2420/03; H04R 2420/01

(57) ABSTRACT

The present invention includes: a connecting plug configured to be connected to the quadripolar input/output interface of a portable terminal, and to transmit or receive output or input signals; and a function unit configured to be supplied with operating power from the portable terminal via the connecting plug, and to perform an intrinsic function; wherein the connecting plug includes a first pole configured to come into contact with the first output terminal of the portable terminal; a second pole configured to come into contact with the second output terminal of the portable terminal; a third pole configured to come into contact with the microphone terminal of the portable terminal; and a fourth pole configured to come into contact with the ground terminal of the portable terminal; and wherein the function unit is supplied with operating power via any one of the first pole, the second pole, and the third pole.

### TECHNICAL FIELD

The present invention relates to an accessory for a portable terminal.

### BACKGROUND ART

Recently, with the improvement of the performance of portable terminals, such as smartphones and tablet PCs, and with the provision of various devices usable in conjunction with such portable terminals, the users of portable terminals have become capable of being provided with various functions via auxiliary devices connected to the portable terminals, in addition to various types of content contained in the portable terminals.

For example, various devices, such as a lighting device, a sensor, a photographing device, etc., can be connected to and used in conjunction with portable terminals, in addition to earphones and a speaker connectable to the portable terminals. Furthermore, configurations for implementing various functions can be added to and used in existing auxiliary devices connectable to portable terminals, such as earphones, a speaker and the like.

As a preceding document for a conventional technology configured to enable a device having a predetermined function to operate in conjunction with a portable terminal and to implement the function, there is Korean Patent No. 10-1178246 entitled “Smartphone Credit Card Payment System and Method using Earphone Jack” (hereinafter referred to as the “conventional technology”).

In the case of this conventional technology, credit card payment is performed by connecting and combining a portable credit card payment device having a magnetic reader to and with a terminal.

Furthermore, in the case of Korean Patent Application Publication No. 10-2010-0001586, i.e., a preceding document, entitled “Quadripolar Earphones and Portable terminal connectable thereto” (hereinafter referred to as the “conventional technology”), a function is performed to control various programs inside a portable terminal by emitting DTMF signals from earphones connected to the portable terminal.

However, in the case of this conventional technology, for the auxiliary devices connected to the portable terminal to perform the functions thereof, a configuration in which separate means for performing power supply, i.e., a battery and a commercial battery, must be added to each of the auxiliary devices. Accordingly, the size of the device increases and the configuration of the device becomes complex, with the result that problems arise in that the portability of the device is degraded and significant inconvenience is caused in the case of simultaneous use via connection with a portable terminal.

### DISCLOSURE

### Technical Problem

The present invention has been contrived to overcome the above problems, and an object of the present invention is to provide technology that is capable of providing power without requiring a separate power supply means for the performance of the intrinsic function of an accessory for a portable terminal inside the accessory.

### Technical Solution

In order to accomplish the above object, the present invention provides an accessory for a portable terminal, the accessory including: a connecting plug configured to be connected to the quadripolar input/output interface of a portable terminal, and to transmit or receive output or input signals via the portable terminal; and a function unit configured to receive operating power from the portable terminal via the connecting plug, and to perform an intrinsic function; wherein the connecting plug includes a first pole configured to come into contact with the first output terminal of the portable terminal; a second pole configured to come into contact with the second output terminal of the portable terminal; a third pole configured to come into contact with the microphone terminal of the portable terminal; and a fourth pole configured to come into contact with the ground terminal of the portable terminal; and wherein the function unit receives operating power from the portable terminal via any one of the first pole, the second pole, and the third pole.

In this case, the accessory for a portable terminal may further include a first switching unit configured to selectively open or close a path through which operating power is supplied from the first pole to the function unit; a second switching unit configured to selectively open or close a path through which operating power is supplied from the second pole to the function unit; and a third switching unit configured to selectively open or close a path through which operating power is supplied from the third pole to the function unit.

Furthermore, each of the switching units may be turned on in response to operating power provided by the portable terminal.

Moreover, the accessory for a portable terminal may further include: a first speaker configured to output a sound signal applied from the first pole; a second speaker configured to output a sound signal applied from the second pole; and a microphone configured to apply an input voice signal to the third pole.

### Advantageous Effects

According to the present invention, when the function unit of the accessory for a portable terminal is operated, power is supplied from the portable terminal via the poles provided in the connecting plug, and thus there is no need for a separate battery and a separate power supply means inside the accessory for a portable terminal, thereby improving the portability of a manufactured accessory for a portable terminal.

Furthermore, according to the present invention, one of existing quadripolar lines is changed into and used as a power supply line, and thus there is no need to additionally design the configuration of a power supply line adapted to be connected to the accessory for a portable terminal and supply power to the accessory for a portable terminal.

### DESCRIPTION OF DRAWINGS

FIG. 1 shows the connection manner of an accessory for a portable terminal according to an embodiment of the present invention;

FIG. 2 shows the quadripolar configuration of a connecting plug according to an embodiment of the present invention as an example; and

FIG. 3 is a block diagram showing the circuit configuration of an accessory for a portable terminal according to an embodiment of the present invention.

### MODE FOR INVENTION

Preferred embodiments of the present invention will be described in greater detail with reference to the accompanying drawings. Descriptions of well-known technical parts will be omitted or abridged for brevity of description.

Referring to FIGS. 1 to 3, components according to an embodiment of an accessory 100 for a portable terminal of the present invention are now described. The accessory 100 for a portable terminal of the present invention includes: a connecting plug 110; and a function unit 120.

The connecting plug 110 is connected to the quadripolar input/output interface 220 of the portable terminal 200, and transmits and receives input and output signals via the portable terminal 200.

In this case, the portable terminal 200 includes the quadripolar input/output interface 220 so that devices having a quadripolar plug, such as earphones, can be connected thereto and then function. As shown in FIG. 1, the accessory 100 for a portable terminal may be provided in the form of a quadripolar plug to be connected to the quadripolar input/output interface 220 via the connecting plug 110 and to transmit or receive output or input signals.

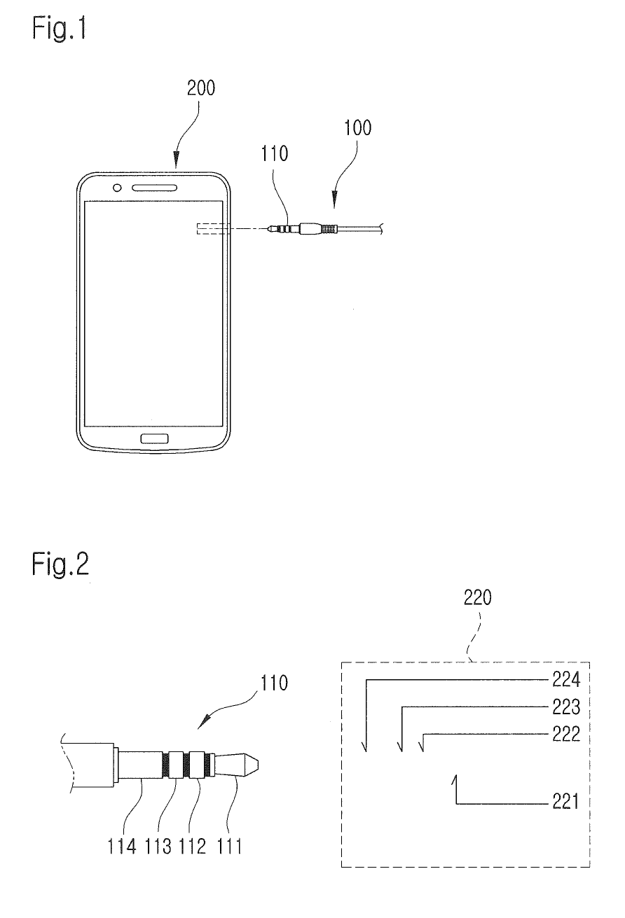

As shown in FIG. 2, the connecting plug 110 includes a first pole 111, a second pole 112, a third pole 113, and a fourth pole 114, and the quadripolar input/output interface 220 includes a first output terminal 221, a second output terminal 222, a microphone terminal 223, and a ground terminal 224.

The connecting plug 110 configured as described above is inserted into the quadripolar input/output interface 220, and thus the first pole 111 is connected to the first output terminal 221, the second pole 112 is connected to the second output terminal 222, the third pole 113 is connected to the microphone terminal 223, and the fourth pole 114 is connected to the ground terminal 224, thereby enabling the transmission and reception of the input and output signals of the portable terminal 200 and the accessory 100 for a portable terminal.

The function unit 120 receives operating power from the portable terminal 200, and performs an intrinsic function that is possessed by the accessory 100 for a portable terminal. In this case, the function unit 120 may vary according to the type of accessory 100 for a portable terminal in various manners.

For example, the function unit 120 may perform a function of Active Noise Control (ANC) via an operation of amplifying and converting a voice signal, an operation of outputting a cancellation sound so as to remove noise, or the like, or may perform a multimedia playback operation in the case of a media player. Furthermore, the function unit 120 may be a device, such as a lighting device, a sensor, or the like, in which case the function unit 120 may perform an operation, such as an operation of emitting light, the sensing function of the sensor, or the like.

In this case, the function unit 120 requires operating power used to perform a function varying according to the type of accessory 100 for a portable terminal. The operating power is transferred from the power supply 210 of the portable terminal 100 through a conducting line, formed by contact between the quadripolar input/output interface 220 and the connecting plug 110, to the function unit 120 of the accessory 100 for a portable terminal.

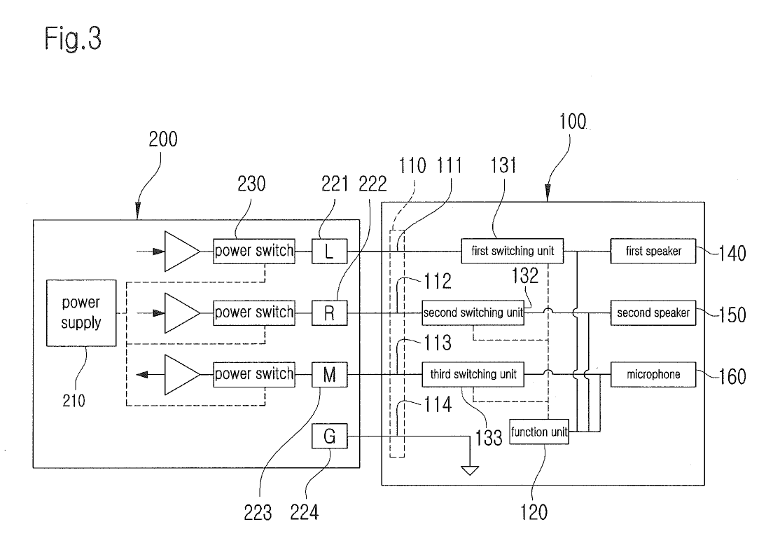

In this case, as shown in FIG. 3, a path for operating power extending from the power supply 210 to the function unit 120 is implemented as any one of a signal line formed by contact between the first pole 111 and the first output terminal 221, a signal line formed by contact between the second pole 112 and the second output terminal 222, and a signal line formed by contact between the third pole 113 and the microphone terminal 223.

Furthermore, the accessory 100 for a portable terminal further includes switching units 131, 132 and 133 configured to maintain connection to the function unit 220 in a turned-off state so that input signals received by the individual poles 111, 112 and 113 of the connecting plug 110 can be prevented from being transferred to the function unit 220 before operating power is applied from the power supply 210 of the portable terminal 200.

That is to say, the individual switching units 131, 132 and 133 function to selectively open or dose paths through which operating power is supplied from the individual pones 111, 112 and 113 to the function unit 120.

The switching units 131, 132 and 133 include: a first switching unit 131 configured to connect the function unit 120 and the first pole 111; a second switching unit 132 configured to connect the function unit 120 and the second pole 112; and a third switching unit 133 configured to connect the function unit 120 and the third pole 113.

In this case, the individual switching units 131, 132 and 133 are turned on in response to the operating power provided by the portable terminal 200.

Furthermore, the portable terminal 200 provides a power supply line configured to transfer operating power from the power supply 210 so that the power supply line can be connected and transfer the operating power to one of the first output terminal 221, the second output terminal 222, and the microphone terminal 223. Power switches 230 are provided at connection points each adapted to connect each of the terminals 221, 222 and 223 inside the portable terminal 200 to the power supply 210, and thus the switches are each turned on only when operating power is applied and only one of the three terminals 221, 222 and 223 is connected to the power supply 210.

That is to say, as shown in FIG. 3, the power supply 210 turns on the power switch 230 for any one of the first output terminal 221, second output terminal 222 and microphone terminal 223 of the quadripolar input/output interface 220, is connected thereto, and supplies operating power. The transferred operating power is applied to the accessory 100 for a portable terminal via a part of the first pole 111, second pole 112 and third pole 113 of the connecting plug 110 that comes into contact with the quadripolar input/output interface 220 to which the power supply 210 is connected. Thereafter, the pole 111, 112 or 113 of the connecting plug 110 having received the operating power forms a signal line, adapted to supply the operating power to the function unit 120, by turning on the switching unit 131, 132 or 133 connected thereto.

In this case, the remaining signal lines not having received the operating power receive input signals adapted to perform basic functions exclusive of the transfer of the operating power.

Accordingly, the accessory 100 for a portable terminal of the present invention further includes: a first speaker 140 configured to output a sound signal applied by the first pole 111; a second speaker 150 configured to output a sound signal applied by the second pole 112; and a microphone 160 configured to apply a voice signal input via the third pole 113.

That is to say, the individual switching units 131, 132 and 133 normally maintain a state of being turned off because operating power is not applied. In this case, the sound signal output from the first output terminal 221 and applied to the first pole 111 is not transferred to the function unit 120 and is output to the first speaker 140 by the turned-off first switching unit 131. Furthermore, the sound signal output from the second output terminal 222 and applied to the second pole 112 is not transferred to the function unit 120 and is output to the second speaker 150 by the turned-off second switching unit 132.

Furthermore, the voice signal input via the microphone 160 is not transferred to the function unit 120 and is applied to the third pole 113 and output to the microphone terminal 223 by the turned-off third switching unit 133, thereby being transferred into the portable terminal 200.

As a result, the function unit 120 having received the operating power functions to perform the intrinsic function of the accessory 100 for a portable terminal provided in a specific form. Accordingly, the accessory 100 for a portable terminal can be supplied with power without a need for the provision of its own power supply provided inside the accessory 100 or a need for the additional design of a separate power supply line.

The embodiments disclosed herein are not intended to limit the technical spirit of the present invention, but are intended to illustrate the technical spirit of the present invention. The scope of the technical spirit of the present invention is not limited by the embodiments. The range of protection should be interpreted based on the attached claims. All technical spirits that fall within a range equivalent to the former range should be construed as pertaining to the range of the rights of the present invention.

### DESCRIPTION OF REFERENCE SYMBOLS

100: accessory for a portable terminal

110: connecting plug

111: first pole

112: second pole

113: third pole

114: fourth pole

120: function unit

131: first switching unit

132: second switching unit

133: third switching unit

140: first speaker

150: second speaker

160: microphone

200: portable terminal

210: power supply

220: quadripolar input/output interface

221: first output terminal

222: second output terminal

223: microphone terminal

224: ground terminal

230: power switch

1. An accessory for a portable terminal, the accessory comprising:
a connecting plug configured to be connected to a quadripolar input/output interface of a portable terminal, and to transmit or receive output or input signals via the portable terminal; and
a function unit configured to receive operating power from the portable terminal via the connecting plug, and to perform an intrinsic function;
wherein the connecting plug comprises a first pole configured to come into contact with a first output terminal of the portable terminal; a second pole configured to come into contact with a second output terminal of the portable terminal; a third pole configured to come into contact with a microphone terminal of the portable terminal; and a fourth pole configured to come into contact with a ground terminal of the portable terminal; and
wherein the function unit receives operating power from the portable terminal via any one of the first pole, the second pole, and the third pole.

2. The accessory for a portable terminal of claim 1, further comprising:
a first switching unit configured to selectively open or close a path through which operating power is supplied from the first pole to the function unit;
a second switching unit configured to selectively open or close a path through which operating power is supplied from the second pole to the function unit; and
a third switching unit configured to selectively open or close a path through which operating power is supplied from the third pole to the function unit.

3. The accessory for a portable terminal of claim 2, wherein each of the switching units is turned on in response to operating power provided by the portable terminal.

4. The accessory for a portable terminal of claim 1, further comprising:
a first speaker configured to output a sound signal applied from the first pole;
a second speaker configured to output a sound signal applied from the second pole; and
a microphone configured to apply an input voice signal to the third pole.
